(19) United States
(12) Patent Application Publication
(10) Pub. No.: US 2009/0117374 A1
(43) Pub. Date: May 7, 2009

(54) POLYIMIDE FILM FOR METALLIZING, AND METAL-LAMINATED POLYIMIDE FILM

(75) Inventors: Kazuyuki Hamada, Yamaguchi (JP); Hidenori Mii, Yamaguchi (JP); Akira Kawabata, Yamaguchi (JP); Yasuhiro Nagoshi, Yamaguchi (JP); Toshiyuki Nishino, Yamaguchi (JP)

Correspondence Address: KNOBBE MARTENS OLSON & BEAR LLP, 2040 MAIN STREET, FOURTEENTH FLOOR, IRVINE, CA, 92614, US

(73) Assignee: Ube Industries, Ltd., Ube (JP)

(21) Appl. No.: 12/297,606

(22) PCT Filed: Apr. 18, 2007
(86) PCT No.: PCT/JP2007/058463

§ 371 Date: Nov. 13, 2008

(30) Foreign Application Priority Data
Apr. 18, 2006 (JP) 2006-114983

(51) Int. Cl. B32B 15/08; B32B 27/00; B32B 27/06; B32B 27/08

(52) U.S. Cl. 428/336; 428/473.5; 428/447; 428/458

(57) ABSTRACT

Disclosed is a polyimide film for metallizing, which has a polyimide layer (a) containing a surface treatment agent on one side or both sides of a polyimide layer (b). A metal layer may be directly formed on the surface of the polyimide film by a metallizing method, thereby providing a metal-laminated polyimide film with excellent adhesiveness.

### TECHNICAL FIELD

The present invention relates to a polyimide film for metallizing on which a metal layer may be formed by a metallizing method, and this polyimide film for metallizing may be used as a material for an electronic component such as a printed wiring board, a flexible printed circuit board, a TAB tape and the like. A metal layer can be formed on this polyimide film for metallizing by a metallizing method to prepare a metal-laminated polyimide film with excellent adhesiveness, on which a metal-plated layer can be formed by a metal plating method to prepare a metal plating laminated polyimide film.

### BACKGROUND ART

Conventionally, since polyimide is excellent in various properties such as heat resistance, dimensional stability, mechanical properties, electric properties, environmental resistance, flame resistance and the like, and has flexibility, it has been widely used as a flexible printed circuit board or a board for tape automated bonding on which a semiconductor integrated circuit is mounted. In these fields, a polyimide film has been used as an insulating support of a laminate wherein a metal foil such as a copper foil or the like is laminated on the polyimide film by means of an adhesive agent. Furthermore, in recent years, a metal layer has also been formed on a polyimide film by a metallizing method.

Meanwhile, in recent years, with the demand for high functionality in the fields such as an electric/electronic device field, a semiconductor field and the like, there is the need for the reduction in thickness of the polymide film.

Patent Document 1 discloses a polyimide film having a metal film which comprises a film base material made of a BPDA-based polyimide using biphenyltetracarboxylic dianhydride as a raw material, an intermediate layer composed of a PMDA-based polyimide using pyromellitic dianhydride as a raw material formed on at least one side of the film base material, and a metal vapor deposition layer and a metal plating layer successively formed on the intermediate layer; and has the contact surface of the film base material with the intermediate layer with a surface roughness, Ra value, of from 0.02 to 0.2 μm.

Patent Document 2 discloses a copper-clad laminated substrate comprising a polyimide film with a thickness of 7 to 125 μm which has a high heat resistant aromatic polyimide layer containing a biphenyl tetracarboxylic acid component as a support layer, and a flexible polyimide layer containing a flexible bond in a main chain as a surface layer; wherein a surface of the flexible polyimide layer of a polyimide film is subjected to an electric discharge treatment under reduced pressure; the treated surface has an uneven shape having projections of a mesh structure; and a metal layer composed of at least two layers of thin metal films (metal vapor deposition layers) and a copper-plated layer are formed on the surface subjected to the electric discharge treatment under reduced pressure.

Patent Document 3 discloses a metal laminated film obtained by forming a metal layer by metallization on one side or both sides of a film obtained by coating one side or both sides of a non-thermoplastic polyimide film with a thermoplastic polyimide varnish or a polyamic acid varnish, and then drying the resulting film.

Furthermore, Patent Document 4 discloses a polyimide film with improved adhesiveness obtained by applying a silane coupling agent to one side or both sides of a polyimide film, wherein the silane coupling agent is an aminosilane.

Patent Document 5 discloses a polyimide film with improved adhesiveness which has a thin layer prepared by heating a coating layer containing a heat resistant surface treatment agent and a polyimide precursor to give a highly heat resistant noncrystalline polyimide (B) on at least one side of a core layer of a polyimide (A) having high rigidity and a low linear expansion coefficient. In Patent Document 57 it is mentioned that this polyimide film may be used as a base film for a metal-clad laminate prepared by a sputtering method, for example, or a base film for a metal vapor deposition film. However, there are no such Examples. Patent Document 5 merely contains Examples in which a copper foil is laminated on a polyimide film by means of an adhesive agent.

Furthermore, Patent Document 6 discloses a thermally fusible polyimide composite film having a thermally fusible layer composed of a polyimide precursor with a volatile content of from 5 to 50% by weight, in which a part of a polyamic acid obtained by reacting biphenyltetracarboxylic dianhydride with an aromatic diamine is converted into an imide, on at least one side of a polyimide film.

### LIST OF REFERENCES

Patent Document 1: Japanese Laid-open Patent Publication No. 1994-210794

Patent Document 2: Japanese Laid-open Patent Publication No. 2003-127275

Patent Document 3: Japanese Laid-open Patent Publication No. 2003-251773

Patent Document 4: Japanese Laid-open Patent Publication No. 1994-336533

Patent Document 5: Japanese Laid-open Patent Publication No. 2005-272520

Patent Document 6: Japanese Laid-open Patent Publication No. 1981-118857

### DISCLOSURE OF THE INVENTION

### Problems to be Solved by the Invention

An object of the present invention is to provide a polyimide film which may be suitably used as a material for an electronic component such as a printed wiring board, a flexible printed circuit board, a TAB tape and the like, and on which a metal layer can be directly formed by a metallizing method to prepare a metal-laminated polyimide film with excellent adhesiveness.

Meanwhile, in cases where a substrate having a metal wiring formed on a polyimide film for metallizing on which a metal layer having good adhesion to the polyimide film may be directly formed by a metallizing method is used, the metal wiring may be buried into the polyimide layer when a chip is mounted on the substrate at a high temperature.

Another object of the present invention is to provide a polyimide film on which a metal layer can be directly formed by a metallizing method, allowing the prevention of burial of a metal wiring into a polyimide layer when a substrate having a metal wiring formed on the polyimide film is placed at a high temperature, for example, for mounting a chip thereon.

### Means for Solving the Problems

The present invention relates to the following matters:

1. A polyimide film for metallizing, having a polyimide layer (a) on one side or both sides of a polyimide layer (b),

wherein the polyimide layer (a) contains a surface treatment agent.

2. A polyimide film for metallizing, having a polyimide layer (a) on one side or both sides of a polyimide layer (b),

wherein the polyimide layer (a) is subjected to a heat treatment at the highest heating temperature of from 350° C. to 600° C. in a state in which it contains a surface treatment agent,

3. A polyimide film for metallizing, obtained by

coating a self-supporting film of a polyimide precursor solution (b) to give a polyimide layer (b) with a polyimide precursor solution (a) containing a surface treatment agent to give a polyimide layer (a); and

heating the self-supporting film of the polyimide precursor solution (b) coated with the polyimide precursor solution (a) containing a surface treatment agent at the highest heating temperature of from 350° C. to 600° C.

4. The polyimide film for metallizing as set forth in any one of the above items 1 to 3, wherein the polyimide layer (a) has a thickness of from 0.05 μm to 1 μm.

5. The polyimide film for metallizing as set forth in any one of the above items 1 to 4, wherein the surface treatment agent is a component selected from the group consisting of an aminosilane compound and an epoxysilane compound.

6. The polyimide film for metallizing as set forth in any one of the above items 1 to 5, wherein the polyimide layer (b) and the polyimide layer (a) are polyimides obtained from

1) an acid component comprising at least one component selected from the group consisting of 3,3′,4,4′-biphenyltetracarboxylic dianhydride, pyromellitic dianhydride, and 1,4-hydroquinone dibenzoate-3,3′,4,4′-tetracarboxylic dianhydride, and

2) a diamine component comprising at least one component selected from the group consisting of p-phenylenediamine, 4,4-diaminodiphenyl ether, o-tolidine, m-tolidine, and 4,4-diaminobenzanilide.

7. The polyimide film for metallizing as set forth in any one of the above items 1 to 5, wherein the polyimide layer (a) is a polyimide obtained from

1) an acid component comprising 3,3′,4,4′-biphenyltetracarboxylic dianhydride, and

2) a diamine component comprising at least one component selected from p-phenylenediamine and 4,4-diaminodiphenyl ether.

8. A metal-laminated polyimide film, comprising the polyimide film for metallizing as set forth in any one of the above items 1 to 7,

wherein a metal layer is formed on the surface of the polyimide layer (a) of the polyimide film for metallizing by a metallizing method.

9. The metal-laminated polyimide film as set forth in the above item 8, wherein the depth of a metal wiring buried in the polyimide film is 0.4 mm or less, and the metal-laminated polyimide film has a normal-state 90° peel strength of 0.8 N/mm or higher.

10. A metal plating laminated polyimide film, comprising the metal-laminated polyimide film as set forth in the above item 8 or 9,

wherein a metal-plated layer is formed on the metal layer of the metal-laminated polyimide film by a metal plating method.

Herein, the depth of a metal wiring buried in the polyimide film is measured in the following manner.

Firstly, a metal wiring polyimide film (10) having a 1 mm-pitch (metal wiring: 0.5 mm in width; interwiring spacing: 0.5 mm in width) metal wiring (2) is prepared from a metal-laminated polyimide film, as shown in FIG. 1(a). Then, as shown in FIG. 1(a), a metal member (3) of 1.6 mm×20 mm is vertically pressed at 15 N on the metal wiring (2) of this metal wiring polyimide film (10), and heated according to a prescribed temperature pattern (heated from 150° C. to 400° C. for 2 to 3 seconds, at 400° C. for 5 seconds, and cooled down from 400° C. to 150° C. for 2 to 3 seconds). After heating, as shown in FIG. 1(b), a part of the metal wiring (2) is buried into the polyimide film (1) of the metal wiring polyimide film (10) to form a metal wiring-buried polyimide film (10a). The number (5) represents the metal wiring-buried area (dented area). And then, the metal wiring in the metal wiring-buried polyimide film (10a) is removed by a known etching method to form a dented polyimide film (1a) as shown in FIG. 1(c). The depth (4) of the dented area from the polyimide surface of the dented polyimide film (1a) is measured, for example, by using a three-dimensional non-contact surface profile measuring system. The maximum value of the measured values is determined to be the depth of the dented area.

Furthermore, the normal-state 90° peel strength is measured in an air-conditioned environment at a temperature of 23° C., using a sample piece of 3 mm to 10 mm in width, in accordance with the method A as described in the copper foil peel strength of JIS (C6471). Incidentally, this sample piece used for measurement is in a normal state, and is not subjected to a heat treatment or the like.

### EFFECT OF THE INVENTION

When using the polyimide film for metallizing of the present invention, a metal layer can be directly formed on the surface of the polyimide film by a metallizing method, to prepare a metal-laminated polyimide film with excellent adhesiveness.

In addition, the polyimide layer (a) is made of a polyimide obtained from a suitable tetracarboxylic dianhydride and a suitable diamine, and the thickness of the polyimide layer (a) is controlled, thereby providing a polyimide film having reduced metal wiring-buried property, i.e. the depth of a metal wiring buried in the polyimide film.

A metal-plated layer can be formed by a metal plating method on a metal layer which is formed on the polyimide film for metallizing of the present invention by a metallizing method to prepare a polyimide film having a metal-plated layer laminated thereon which has good adhesion between the polyimide film and the metal-plated layer.

### BRIEF DESCRIPTION OF THE DRAWINGS

FIG. 1 is a schematic view illustrating the depth of a copper wiring buried in the polyimide film and the evaluation method thereof.

### DESCRIPTION OF THE MAIN SYMBOLS

1: polyimide film,
1a: dented polyimide film,
2: copper wiring,
3; metal member for heating,
4: depth of the dented area,
5: area where a copper wiring is buried under the surface of the film,
10: copper wiring polyimide film,
10a: copper wiring-buried polyimide film.

### BEST MODE FOR CARRYING OUT THE INVENTION

The polyimide film for metallizing of the present invention is obtained by forming a polyimide layer (a) containing a surface treatment agent on one side or both sides of a polyimide layer (b). This polymide layer (a) is preferably subjected to a heat treatment at the highest heating temperature of from 350° C. to 600° C. in a state wherein it contains a surface treatment agent; and it is particularly preferably obtained by heating a polyimide precursor solution layer (a), which is formed by applying a polyimide precursor solution (a) containing a surface treatment agent on a self-supporting film of a polyimide precursor solution (b) or a polyimide layer (b), at the highest heating temperature of from 350° C. to 600° C. Furthermore, it is preferable that the polyimide layer (b) and the polyimide layer (a) are directly laminated.

In the polyimide film for metallizing of the present invention, the thickness of the polyimide layer (b) and that of the polyimide layer (a) may be appropriately selected depending on the intended use, but the thickness of the polyimide layer (b) is practically preferably from 5 to 100 μm, further preferably from 8 to 80 μm, more preferably from 10 to 80 μm, and particularly preferably from 20 to 40 μm.

The thickness of the polyimide layer (a) is preferably from 0.05 to 1 μm, more preferably from 0.06 to 0.8 μm, further preferably from 0.07 to 0.5 μm, and particularly preferably from 0.08 to 0.2 μm. When the thickness of the polyimide layer (a) is within the above range, the metal wiring-buried property is enhanced (the depth of the metal wiring buried in the polyimide film becomes smaller) without lowering the 90° peel strengths of the obtained metal-laminated polyimide film and the obtained metal plating laminated polyimide film. Therefore, it is preferable that the thickness of the polyimide layer (a) is within the above range.

As the polyimide layer (b) and the polyimide layer (a), there can be exemplified a polyimide film used as a material for an electronic component such as a printed wiring board, a flexible printed circuit board, a TAB tape and the like; a polyimide obtained from an acid component and a diamine component constituting the polyimide film, or a polyimide containing an acid component and a diamine component constituting the polyimide film; and the like.

Specific examples of the polyimide layer (b) include a polyimide film used as a material for an electronic component such as a printed wiring board, a flexible printed circuit board, a TAB tape and the like, for example, a polyimide film such as product name: UPILEX (S or R) (a product of Ube Industries, Ltd.), product name: Kapton (a product of Du Pont-Toray Co., Ltd., a product of Du Pont), product name: Apical (a product of Kaneka Corporation) and the like; a polyimide obtained from an acid component and a diamine component constituting these polyimide films, or a polyimide containing an acid component and a diamine component constituting these polyimide films; and the like.

Specific examples of the polyimide layer (a) include a polyimide obtained from an acid component and a diamine component constituting a polyimide film used as a material for an electronic component such as a printed wiring board, a flexible printed circuit board, a TAB tape and the like, for example, a polyimide film such as product name: UPILEX (S or R) (a product of Ube Industries, Ltd.), product name: Kapton (a product of Du Pont-Toray Co., Ltd., a product of Du Pont), product name: Apical (a product of Kaneka Corporation) and the like; a polyimide containing an acid component and a diamine component constituting these polyimide films; and the like.

The polyimide layer (b) and the polyimide layer (a) may be the same combination of an acid component and a diamine component, or may be a different combination of the components.

In the present invention, a polyimide used as the polyimide layer (a) may not be “a heat resistant noncrystalline polyimide” as described in the claims of Japanese Laid-open Patent Publication No. 2005-272520; “a thermoplastic polyimide” as described in the claims of Japanese Laid-open Patent Publication No. 2003-251773; “a heat resistant noncrystalline polyimide” as described in the claims of Japanese Laid-open Patent Publication No. 2005-272520; and “a thermoplastic polyimide” as described in the claims of Japanese Laid-open Patent Publication No. 2003-251773.

A preferable polyimide used as the polyimide layer (b) and the polyimide layer (a) may be a heat resistant polyimide having a glass transition temperature of preferably 250° C. or higher, further preferably 270° C. or higher, more preferably 300° C. or higher, more preferably 320° C. or higher, and particularly preferably 330° C. or higher, or a heat resistant polyimide in which a glass transition temperature is undetectable at a temperature of preferably less than 250° C., further preferably less than 270° C., more preferably less than 300° C., more preferably less than 320° C., and particularly preferably less than 350° C.

A preferable polyamide layer (b) may be a polyimide obtained from

1) an acid component comprising at least one component selected from 3,3′,4,4′-biphenyltetracarboxylic dianhydride, pyromellitic dianhydride, and 1,4-hydroquinone dibenzoate-3,3′,4,4′-tetracarboxylic dianhydride, and

2) a diamine component comprising at least one component selected from diamines containing 1 or 2 benzene nuclei (not containing a C2 or more alkyl chain such as an ethylene chain or the like between 2 benzene nuclei) such as p-phenylenediamine, 4,4-diaminodiphenyl ether, o-tolidine, m-tolidine, 4,4′-diaminobenzanilide, and the like. Furthermore, a polymide film having a linear expansion coefficient (50 to 200° C.) of 5×10⁻⁶ to 30×10⁻⁶ cm/cm/° C. is preferably used as a material for an electronic component such as a printed wiring board, a flexible printed circuit board, a TAB tape and the like.

A particularly preferable polyimide layer (b) may be a polyimide obtained by heat-treating at a temperature of from 350 to 600° C., preferably from 450 to 590° C., more preferably from 490 to 580° C., further preferably from 500 to 580° C., and particularly preferably from 520 to 580° C., because it is used as a material for an electronic component such as a printed wiring board, a flexible printed circuit board, a TAB tape and the like.

Preferable specific examples of the combination of the acid component and the diamine component constituting the polyimide layer (b) include

1) 3,3′,4,4′-biphenyltetracarboxylic dianhydride, and p-phenylenediamine, or p-phenylenediamine and 4,4-diaminodiphenyl ether,

2) 3,3′,4,4′-biphenyltetracarboxylic dianhydride and pyromellitic dianhydride, and p-phenylenediamine, or p-phenylenediamine and 4,4-diaminodiphenyl ether,

3) pyromellitic dianhydride, and p-phenylenediamine and 4,4-diaminodiphenyl ether, and

4) 3,3′,4,4′-biphenyltetracarboxylic dianhydride, and p-phenylenediamine, as main components (50 mole % or more in the total 100 mole %). The polyimides prepared from the above combinations are suitably used as a material for an electronic component such as a printed wiring board, a flexible printed circuit board, a TAB tape and the like. These polyimides are preferable, because they have excellent mechanical properties over a wide temperature range, long-term heat resistance, high resistance to hydrolysis, a high heat-decomposition initiation temperature, a low heat shrinkage ratio, a low linear expansion coefficient, and high flame resistance

A preferable polyimide layer (a) may be a polyimide obtained from

1) an acid component comprising at least one component selected from 3,3′,4,4′-biphenyltetracarboxylic dianhydride, pyromellitic dianhydride, and 1,4-hydroquinone dibenzoate-3,3′,4,4′-tetracarboxylic dianhydride, and

2) a diamine component comprising at least one component selected from diamines containing 1 or 2 benzene nuclei (not containing a C2 or more alkyl chain such as an ethylene chain or the like between 2 benzene nuclei) such as p-phenylenediamine, 4,4-diaminodiphenyl ether, o-tolidine, m-tolidine, 4,4-diaminobenzanilide, and the like. By using such a polyimide as the polyimide layer (a), a polyimide film having reduced metal wiring-buried property can be obtained. Furthermore, a polyimide film having a linear expansion coefficient (50 to 200° C.) of 5×10⁻⁶ to 30×10⁻⁶ cm/cm/° C. is preferably used as a material for an electronic component such as a printed wiring board, a flexible printed circuit board, a TAB tape and the like.

Preferable specific examples of the combination of the acid component and the diamine component constituting the polyimide layer (a) include

1) 3,3′,4,4′-biphenyltetracarboxylic dianhydride, and p-phenylenediamine, or p-phenylenediamine and 4,4-diaminodiphenyl ether, or 4,4-diaminodiphenyl ether,

2) 3,3′,4,4′-biphenyltetracarboxylic dianhydride and pyromellitic dianhydride, and p-phenylenediamine, or p-phenylenediamine and 4,4-diaminodiphenyl ether, or 4,4-diaminodiphenyl ether,

3) pyromellitic dianhydride, and p-phenylenediamine and 4,4-diaminodiphenyl ether, or 4,4-diaminodiphenyl ether, and

4) 3,3′,4,4′-biphenyltetracarboxylic dianhydride, and p-phenylenediamine and/or 4,4-diaminodiphenyl ether, as main components (50 mole % or more in the total 100 mole %). The polyimides prepared from the above combinations are suitably used as a material for an electronic component such as a printed wiring board, a flexible printed circuit board, a TAB tape and the like. These polyimides are preferable, because they have excellent mechanical properties over a wide temperature range, long-term heat resistance, high resistance to hydrolysis, a high heat-decomposition initiation temperature, a low heat shrinkage ratio, a low linear expansion coefficient, and high flame resistance. Furthermore, a polyimide film having more reduced metal wiring-buried property can be obtained.

A particularly preferable polyimide layer (a) may be a polyimide obtained by heat-treating at a temperature of from 350 to 600° C., preferably from 450 to 590° C., more preferably from 490 to 580° C., further preferably from 500 to 580° C., and particularly preferably from 520 to 580° C., because it is used as a material for an electronic component such as a printed wiring board, a flexible printed circuit board, a TAB tape and the like.

A particularly preferable polyimide layer (a) may be a polyimide obtained from

1) an acid component comprising 3,3′,4,4′-biphenyltetracarboxylic dianhydride, and

2) a diamine component comprising at least one component selected from p-phenylenediamine, and 4,4-diaminodiphenyl ether.

Particularly preferable specific examples of the combination of the acid component and the diamine component constituting the polyimide layer (a) include

1) a polyimide obtained from an acid component comprising 3,3′,4,4′-biphenyltetracarboxylic dianhydride in an amount of 30 mole % or more, preferably 50 mole % or more, and more preferably 60 mole % or more; and a diamine component comprising 4,4-diaminodiphenyl ether in an amount of preferably 40 mole % or more, further preferably 60 mole % or more, more preferably 70 mole % or more, and particularly 85 mole % or more, and

2) a polyimide obtained from an acid component comprising 3,3′,4,4′-biphenyltetracarboxylic dianhydride and pyromellitic dianhydride, which comprises 3,3′,4,4′-biphenyltetracarboxylic dianhydride in an amount of 30 mole % or more, preferably 50 mole % or more, and more preferably 60 mole % or more; and a diamine component comprising 4,4-diaminodiphenyl ether and p-phenylenediamine, which comprises 4,4-diaminodiphenyl ether in an amount of preferably 40 mole % or more, further preferably 60 mole % or more, more preferably 70 mole % or more, and particularly 85 mole % or more. These polyimides are preferable, because the obtained metal-laminated polyimide film and the obtained metal plating laminated polyimide film may have high 90° peel strength.

As the diamine component constituting the polyimide layer (a) or the polyimide layer (b), there can be used, in addition to the aforementioned components, aromatic diamines, aliphatic diamines, alicyclic diamines, and the like each containing 3 or more benzene nuclei, besides an aromatic diamine component selected from diamines containing 1 or 2 benzene nuclei (not containing a C2 or more alkyl chain such as an ethylene chain or the like) such as p-phenylenediamine, 4,4-diaminodiphenyl ether, m-tolidine, 4,4′-diaminobenzanilide, and the like, as long as the object of the present invention would not be impaired.

As the acid component constituting the polyimide layer (a) or the polyimide layer (b), there can be used, in addition to the aforementioned components, aromatic acid anhydrides such as 2,3,3′,4′-biphenyltetracarboxylic dianhydride, bis(3,4-dicarboxyphenyl)ether dianhydride, bis(3,4-dicarboxyphenyl)thioether dianhydride, bis(3,4-dicarboxyphenyl)sulfone dianhydride, bis(3,4-dicarboxyphenyl)ketone dianhydride, bis(3,4-dicarboxyphenyl)hexafluoropropane dianhydride (6FDA), naphthalene tetracarboxylic dianhydride, and the like, as long as the object of the present invention would not be impaired.

The polyimide layer (a) of the polyimide film for metallizing of the present invention contains a surface treatment agent. The polyimide layer (a) contains a surface treatment agent) whereby a metal layer having good adhesion to the polyimide film may be directly formed on the surface of the polyimide film by a metallizing method.

The phrase “the polyimide layer (a) contains a surface treatment agent” includes a case in which the surface treatment agent may be contained in the polyimide layer (a) without any treatment, and a case in which the surface treatment agent contained in the polyimide layer (a) may have undergone a change, including chemical change, caused by thermal change, for example, by a heat treatment at a temperature of from 350 to 600° C., preferably from 450 to 590° C., more preferably from 490 to 580° C., further preferably from 500 to 580° C., and particularly preferably from 520 to 580° C. in a polyimide or a polyimide precursor, or an organic solution thereof.

Examples of the surface treatment agent include an aminosilane-based surface treatment agent, an epoxysilane-based surface treatment agent, and a titanate-based surface treatment agent. Examples of the aminosilane-based surface treatment agent include γ-aminopropyl-triethoxy silane, N-β-(aminoethyl)-γ-aminopropyl-triethoxy silane, N-(aminocarbonyl)-γ-aminopropyl-triethoxy silane, N-[β-(phenylamino)-ethyl]-γ-aminopropyl-triethoxy silane, N-phenyl-γ-aminopropyl-triethoxy silane, γ-phenylaminopropyl trimethoxy silane, and the like. Examples of the epoxysilane-based surface treatment agent include β-(3,4-epoxycyclohexyl)-ethyl-trimethoxy silane, γ-glycidoxypropyl-trimethoxy silane, and the like. Examples of the titanate-based surface treatment agent include isopropyl-tricumylphenyl-titanate, dicumylphenyl-oxyacetate-titanate, and the like.

As the surface treatment agent, silane compounds such as an aminosilane-based compound and an epoxysilane-based compound may be preferably used.

In the polyimide layer (a), the content of the surface treatment agent such as a silane compound or the like to be contained in the polyimide precursor solution (a) may be appropriately selected depending on the kind of the polyimide layer (b) in use, and is preferably in the range of 1 to 10% by mass, further preferably in the range of 1.5 to 8% by mass, and particularly preferably in the range of 3 to 6% by mass, based on 100% by mass of the polyimide precursor solution (a).

In the present invention, one side or both sides of a self-supporting film obtained from a polyimide precursor solution to give a polyimide layer (b) is coated with a polyimide precursor solution (a) containing a surface treatment agent to give a polyimide layer (a), thereby laminating the polyimide precursor solution (a) on one side or both sides of the self-supporting film. And then, the obtained multi-layered self-supporting film is heated, dried and imidized, and furthermore, it is preferably heated at the highest heating temperature of from 350 to 600° C., preferably from 450 to 590° C., more preferably from 490 to 580° C., further preferably from 500 to 580° C., and particularly preferably from 520 to 580° C. When conducting the above heat treatment, the obtained polyimide film may have improved adhesiveness, sufficient mechanical property (tensile modulus) and thermal property (linear expansion coefficient) as the whole film, and a laminate in which a metal layer is laminated on the surface of the polyimide layer (a) of this polyimide film by a metallizing method may have a greater peel strength than a practical level.

The self-supporting film obtained from the polyimide precursor solution (b) to give the polyimide layer (b) may be prepared by flow-casting an aromatic polyamic acid solution, which is prepared by polymerizing an acid component and a diamine component in an organic polar solvent substantially in an equimolar amount, or in a little excess amount of any one of these components, on a support; and heating it.

The polyimide precursor solution (a) used for forming the polyimide layer (a) is prepared by polymerizing an acid component and a diamine component in an organic polar solvent substantially in an equimolar amount, or in a little excess amount of any one of these components.

The polyimide layer (a) may be prepared by adding a surface treatment agent such as a silane compound or the like to such a polyimide precursor solution (a); coating the self-supporting film of the polyimide precursor solution (b) to give the polyimide layer (b) with the polyimide precursor solution (a) containing the surface treatment agent; and imidizing the resultant, and further heat-treating it at the highest heating temperature of from 350 to 600° C., preferably from 450 to 590° C., more preferably from 490 to 580° C., further preferably from 500 to 530° C., and particularly preferably from 520 to 580° C.

Examples of the organic polar solvent used for the preparation of a polyimide precursor solution include amide solvents such as N-methyl-2-pyrrolidone, N,N-dimethylacetamide, N,N-diethylacetamide, N,N-dimethylformamide, N,N-diethylformamide, hexamethylsulfonamide, and the like; sulfoxide solvents such as dimethylsulfoxide, diethylsulfoxide, and the like; and sulfone solvents such as dimethylsulfone, diethylsulfone, and the like. These solvents may be used alone, or may be used in combination of two or more.

When conducting the polymerization reaction of the polyimide precursor (a) and the polymerization reaction of the polyimide precursor (b), the concentration of the whole monomer in the organic polar solvent may be appropriately selected depending on the intended use or the purpose of production. For example, for the polyimide precursor solution (b), the concentration of the whole monomer in the organic polar solvent is preferably from 5 to 40% by mass, further preferably from 6 to 35% by mass, and particularly preferably from 10 to 30% by mass, while for the polyimide precursor solution (a), the concentration of the whole monomer in the organic polar solvent is preferably from 1 to 15% by mass, and particularly preferably from 2 to 8% by mass.

As one example of the processes for producing the polyimide precursor (a) and the polyimide precursor (b), the aforementioned polymerization reaction of an aromatic tetracarboxylic acid component and an aromatic diamine component are conducted by, for example, mixing these components substantially in an equimolar amount, or in a little excess amount of any one of the components (an acid component or a diamine component); and reacting at a reaction temperature of 100° C. or lower, preferably 80° C. or lower, for about 0.2 to 60 hours, whereby a polyamic acid (polyimide precursor) solution may be obtained.

When conducting the polymerization reaction of the polyimide precursor (a) and the polymerization reaction of the polyimide precursor (b), the solution viscosity may be appropriately selected depending on the intended use (coating, flow-casting or the like) or the purpose of production. The polyamic acid (polyimide precursor) solution preferably has a rotational viscosity measured at 30° C. of from about 0.1 to 5,000 poise, particularly from about 0.5 to 2,000 poise, and further preferably from about 1 to 2,000 poise, in view of handling and workability of the polyamic acid solution. Accordingly, the aforementioned polymerization reaction is preferably carried out so as to give a polyamic acid solution having a viscosity within the above range.

For preparing the self-supporting film of the polyimide precursor solution (b) to give the polyimide layer (b), for example, firstly, the polyimide precursor solution (b) is flow-casted on a surface of a suitable support (for example, a metal roll, a ceramic plastic roll, or a metallic belt, or a roll or a belt supplying a metal thin film tape) to form a film of a polyimide precursor solution with a uniform thickness of about 10 to 2,000 μm, particularly about 20 to 1,000 μm. Subsequently, the film of the polyimide precursor solution (b) is heated at a temperature of from 50 to 210° C., particularly from 60 to 200° C., using a heat source such as hot air, infrared ray or the like, thereby gradually removing a solvent and pre-drying it to make it self-supporting, and then the resulting self-supporting film is peeled off from the support.

In the preparation of the self-supporting film of the polyimide precursor solution (b) to give the polyimide layer (b), imidization of the polyimide precursor (b) may be conducted by thermal imidization or by chemical imidization.

When coating the self-supporting film with the polyimide precursor solution (a), the polyimide precursor solution (a) may be applied onto the self-supporting film peeled off from the support, or alternatively, the polyimide precursor solution (a) may be applied onto the self-supporting film on the support before peeling off from the support.

It is preferable that the self-supporting film has a surface (on one side or both sides) such that a polyimide precursor solution (a) to give a polyimide (a) may be substantially uniformly, further preferably uniformly, applied onto the surface of the self-supporting film.

It is preferable that a polyimide precursor solution (a) to give a polyimide (a) is uniformly applied on one side or both sides of the self-supporting film.

A polyimide precursor solution (a) to give a polyimide (a) can be applied on one side or both sides of the self-supporting film by any known method; for example, by a gravure coating method, a spin coating method, a silk screening method, a dip coating method, a spray coating method, a bar coating method, a knife coating method, a roll coating method, a blade coating method, a die coating method, and the like.

For the peeled self-supporting film, its weight loss on heating is preferably in the range of 20 to 40% by mass, and its imidization rate is preferably in the range of 8 to 40%, because when the weight loss on heating and the imidization rate is out of the above range, the self-supporting film may not have sufficient mechanical properties, the polyimide precursor solution (a) may not be evenly applied to the surface of the self-supporting film, the obtained polyimide film may not have good adhesion between the polyimide layer (a) and the polyimide layer (b), or foaming, flaws, crazes, cracks, fissures and the like may be observed in the polyimide film obtained after imidization.

Incidentally, the weight loss on heating of a self-supporting film as described above is calculated by the following formula from the weight before drying (W1) and the weight after drying (W2) of the film to be measured when the film is dried at 420° C. for 20 minutes.

Weight loss on heating (% by mass)={(W1−W2)/W1}×100

Furthermore, the imidization rate of a self-supporting film as described above can be calculated based on the ratio of the vibration band peak area measured with IR spectrometer (ATR) between the film and the fully-cured product. The vibration band peak utilized in the procedure may include a symmetric stretching vibration band of an imidecarbonyl group, a stretching vibration band of a benzene ring skeleton, and the like. Furthermore, the imidization rate can be also determined in accordance with the method as described in the Japanese Laid-open Patent Publication No. 1997-316199, using a Karl Fischer's moisture meter.

In addition, the aforementioned self-supporting film may contain a fine inorganic or organic additive therein or in a surface layer thereof, if necessary.

As the inorganic additive, there can be exemplified a particulate or flat inorganic filler. Examples thereof include particulate inorganic oxide powder such as titanium dioxide powder, silicon dioxide (silica) powder, magnesium oxide powder, aluminum oxide (alumina) powder, zinc oxide powder and the like; particulate inorganic nitride powder such as silicon nitride powder, titanium nitride powder and the like; inorganic carbide powder such as silicon carbide powder and the like; and particulate inorganic powder such as calcium carbonate powder, calcium sulfate powder, barium sulfate powder and the like. These inorganic fine particles may be used in combination of two or more. In order to homogeneously disperse these inorganic fine particles, a known method may be used.

Examples of the organic additive include polyimide particles, thermosetting resin particles and the like.

The amount and shape (size, aspect ratio) of the additive in use are preferably selected depending on the intended use.

The coating film (laminate) prepared as described above is preferably fixed by means of a pintenter, a clip, a metal or the like, and heat-cured. This heat treatment preferably consists of a first heat treatment at a temperature of from 200° C. to less than 300° C. for 1 to 60 minutes, a subsequent second heat treatment at a temperature of from 300° C. to less than 370° C. for 1 to 60 minutes, and a third heat treatment at the highest heating temperature of from 350° C. to 600° C., preferably from 450° C. to 590° C., more preferably from 490° C. to 580° C., further preferably from 500° C. to 580° C. and particularly preferably from 520° C. to 580° C. for 1 to 30 minutes. In this way the stepwise heat treatment is preferably carried out. When the first heat treatment temperature is lower than 200° C., the polyimide may be hydrolyzed due to water generated in the formation of metal oxide, leading to deterioration in the mechanical properties and a crack in the film. The above heat treatment may be carried out using various known apparatuses such as a hot air furnace, an infrared heating furnace, or the like.

For the purpose of preventing gelation, a phosphorus stabilizer such as triphenyl phosphite, triphenyl phosphate, and the like may be added to the polyimide precursor solution (a) and/or the polyimide precursor solution (b) in the range of 0.01 to 1%, based on the solid content (polymer) concentration in the polymerization of the polyamic acid.

For the purpose of accelerating imidization, a basic organic compound may be added to a dope of the polyimide precursor solution (a) and/or the polyimide precursor solution (b). For example, imidazole, 2-imidazole, 1,2-dimethylimidazole, 2-phenylimidazole, benzimidazole, isoquinoline, substituted pyridine, and the like may be used at a ratio of 0.0005 to 0.1 parts by mass, particularly 0.001 to 0.02 parts by mass, based on 100 parts by mass of the polyamic acid (polyimide precursor). These may be used in order to avoid insufficient imidization in the formation of the polyimide film at a relatively low temperature according to the present invention.

Furthermore, for the purpose of stabilizing adhesiveness of the polyimide film obtained, an organic aluminum compound, an inorganic aluminum compound, or an organic tin compound may be added to a dope for a thermocompression-bonding polyimide. For example, aluminum hydroxide, aluminum triacetylacetonate, and the like may be added at a ratio of 1 ppm or more, particularly from 1 to 1,000 ppm, as an aluminum metal, relative to the polyamic acid.

The polyimide film for metallizing obtained by laminating the polyimide layer (a) and the polyimide layer (b) may preferably have a tensile modulus (MD) of 6 GPa or more, preferably 12 GPa or less, and a linear expansion coefficient (50 to 200° C.) of from 10×10⁻⁶ to 30×10⁻⁶ cm/cm/C as the whole film, because it may be suitably used as a material for an electronic component such as a printed wiring board, a flexible printed circuit board, a TAB tape and the like.

The polyimide film for metallizing of the present invention may be used without any treatment, or may be used after subjecting the polyimide layer (a) or the polyimide layer (b) to surface treatment such as corona discharge treatment, low-temperature plasma discharge treatment, atmospheric-pressure plasma discharge treatment, chemical etching and the like, as necessary.

A metal layer may be formed by a metallizing method on the surface of the polyimide layer (a) of the polyimide film for metallizing of the present invention. The obtained metal-laminated polyimide film may preferably have an adhesion between the polyimide layer (a) and the metal layer (90° peel strength) of 0.8 N/mm or higher, further 1.1 N/mm or higher, and particularly 1.2 N/mm or higher in a normal state, and preferably have a 90° peel strength of 0.4 N/mm or higher, further 0.7 N/mm or higher, and particularly 0.8 N/mm or higher after heat treatment at 150° C. for 168 hours. Furthermore, the depth of a metal wiring buried in the polyimide film may be preferably 0.4 mm or less, and further 0.25 mm or less.

As described above, using the polyimide film for metallizing of the present invention, a metal-laminated polyimide film may be prepared by forming a metal layer on the surface of the polyimide layer (a) of the polyimide film by a metallizing method, after subjecting the surface of the polyimide layer (a) to surface treatment, as necessary.

Furthermore, using this metal-laminated polyimide film, a metal plating laminated polyimide film may be prepared by forming a metal-plated layer on the metal layer of the metal-laminated polyimide film by a metal plating method.

The metal layer formed by a metallizing method may be any metal layer, as long as it has sufficient adhesiveness to the polyimide layer (a) of the polyimide film for metallizing, and has sufficient adhesiveness to the metal-plated layer to be formed thereon without causing any practical problem.

The metallizing method is a method for forming a metal layer, different from metal plating or metal foil lamination. As this method, any known method such as vapor deposition, sputtering, ion plating, electron-beam evaporation, and the like may be used.

Examples of the metal used in the metallizing method include, but not limited to, metals such as copper, nickel, chromium, manganese, aluminum, iron, molybdenum, cobalt, tungsten, vanadium, titanium, tantalum and the like, and alloys thereof, oxides thereof, and carbides thereof.

The thickness of the metal layer formed by a metallizing method may be appropriately selected depending on the intended use, and it is preferably in the range of 1 to 500 mm, and further preferably in the range of 5 to 200 nm for practical use.

The number of the metal layers formed by a metallizing method may be appropriately selected depending on the intended use, and it may be 1 layer, 2 layers, 3 or more layers.

A metal-plated layer such as a copper-plated layer, a tin-plated layer, or the like can be formed on the surface of the metal layer of the metal-laminated polyimide film by a known wet plating method such as electrolytic plating or non-electrolytic plating.

The thickness of the metal-plated layer such as a copper-plated layer or the like formed on the metal-laminated polyimide film may be preferably in the range of 1 to 40 μm for practical use.

### EXAMPLES

The present invention is now described in more detail below with reference to Examples. However, the present invention is not restricted to these Examples.

(Evaluation Method)

1. Peel strength (90° peel strength): It was measured in an air-conditioned environment at a temperature of 23° C., using a sample piece of 3 to 10 mm in width, in accordance with the method A as described in the copper foil peel strength of JIS (C6471). The measurement was carried out two times, and the average of the measured values is shown in Table 1.

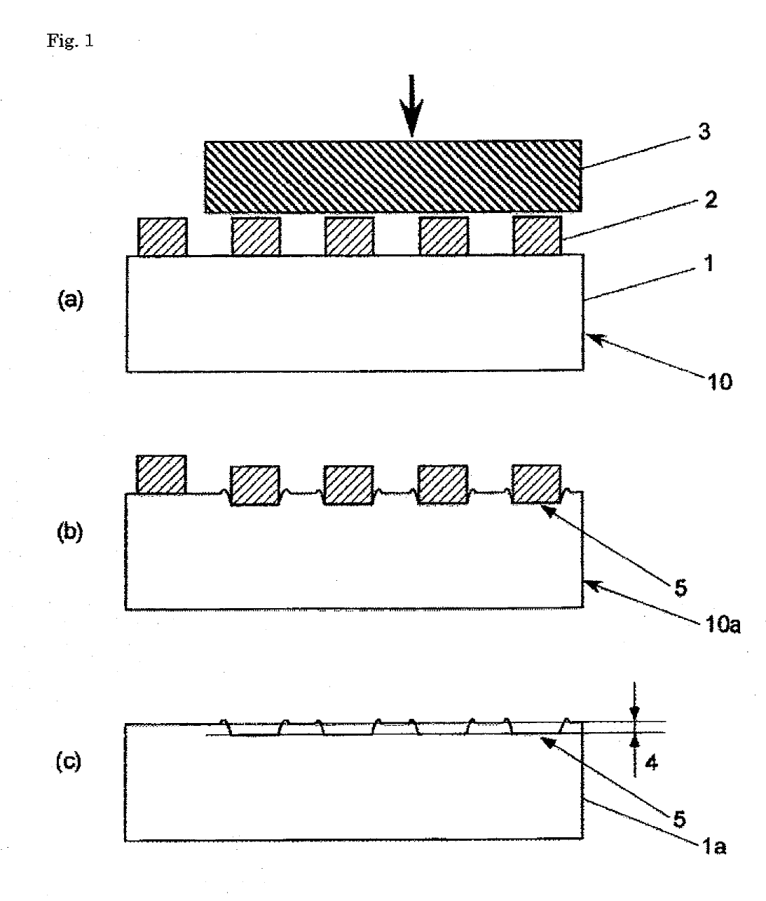

2. Depth of the dented area (Depth of a metal wiring buried in the polyimide film): A copper wiring polyimide film (10) having a 1 mm-pitch (copper wiring: 0.5 mm in width; interwiring spacing: 0.5 mm in width) copper wiring (2) was prepared from a copper plating laminated polyimide film, as shown in FIG. 1(a). Then, as shown in FIG. 1(a), a metal member (3) of 1.6 mm×20 mm was vertically pressed at 15 N on the copper wiring (2) of this copper wiring polyimide film (10), and heated according to a prescribed temperature pattern (heated from 150° C. to 400° C. for 2 to 3 seconds, at 400° C. for 5 seconds, and cooled down from 400° C. to 150° C. for 2 to 3 seconds). After heating, as shown in FIG. 1(b), a part of the copper wiring (2) was buried into the polyimide film (1) to form a copper wiring-buried polyimide film (10a). This copper wiring-buried polyimide film (10a) was immersed in an aqueous solution of ferric chloride for 15 minutes for removing the copper wiring by etching, and then dried at 80° C. for 30 minutes to form a dented polyimide film (1a) as shown in FIG. 1(c). The depth (4) of the dented area from the polyimide surface of the dented polyimide film (1a) was measured by using a three-dimensional non-contact surface profile measuring system (MM520ME-M100, a product of Ryoka Systems Inc.). The maximum value of the measured values is determined to be the depth of the dented area.

### Reference Example 1

3,3′,4,4′-biphenyltetracarboxylic dianhydride and p-phenylenediamine of an equimolar amount were polymerized in N,N-dimethylacetamide at 30° C. for 3 hours to obtain a polyamic acid solution having a concentration of 18% by mass. To this polyamic acid solution were added 0.1 parts by mass of monostearyl phosphate triethanolamine salt based on 100 parts by mass of the polyamic acid, subsequently 0.05 mole of 1,2-dimethylimidazole based on 1 mole of the polyamic acid, and 0.5 parts by mass of a silica filler (average particle size: 0.08 μm, ST-ZL manufactured by Nissan Chemical Industries, Ltd.) based on 100 parts by mass of the polyamic acid, and then the resulting mixture was homogeneously mixed to obtain a precursor solution composition (B-1) of a polyimide (b).

### Reference Example 2

3,3′,4,4′-biphenyltetracarboxylic dianhydride and p-phenylenediamine of an equimolar amount were polymerized in N,N-dimethylacetamide at 30° C. for 3 hours to obtain a polyamic acid solution having a concentration of 3.0% by mass. To this polyamic acid solution were added 0.5 parts by mass of a silica filler (average particle size: 0.08 μm, ST-ZL manufactured by Nissan Chemical Industries, Ltd.) based on 100 parts by mass of the polyamic acid, and γ-phenylaminopropyl trimethoxy silane at a ratio such that the concentration in the solution was 3% by mass, and then the resulting mixture was homogeneously mixed to obtain a precursor solution composition (A-1) of a polyimide (a).

### Reference Example 3

3,3′,4,4′-biphenyltetracarboxylic dianhydride and 4,4-diaminodiphenyl ether of an equimolar amount were polymerized in N,N-dimethylacetamide at 30° C. for 3 hours to obtain a polyamic acid solution having a concentration of 3-0% by mass. To this polyamic acid solution were added 0.5 parts by mass of a silica filler (average particle size: 0.08 μm, ST-ZL manufactured by Nissan Chemical Industries, Ltd.) based on 100 parts by mass of the polyamic acid, and γ-phenylaminopropyl trimethoxy silane at a ratio such that the concentration in the solution was 3% by mass, and then the resulting mixture was homogeneously mixed to obtain a precursor solution composition (A-2) of a polyimide (a)

### Reference Example 4

3,3′,4,4′-biphenyltetracarboxylic dianhydride, 4,4-diaminodiphenyl ether and p-phenylenediamine at a molar ratio of 100:80:20 were polymerized in N,N-dimethylacetamide at 30° C. for 3 hours to obtain a polyamic acid solution having a concentration of 3.0% by mass. To this polyamic acid solution were added 0.5 parts by mass of a silica filler (average particle size: 0.08 μm, ST-ZL manufactured by Nissan Chemical Industries, Ltd.) based on 100 parts by mass of the polyamic acid, and γ-phenylaminopropyl trimethoxy silane at a ratio such that the concentration in the solution was 3% by mass, and then the resulting mixture was homogeneously mixed to obtain a precursor solution composition (A-3) of a polyimide (a).

### Reference Example 5

3,3′,4,4′-biphenyltetracarboxylic dianhydride, 4,4-diaminodiphenyl ether and p-phenylenediamine at a molar ratio of 100:30:70 were polymerized in N,N-dimethylacetamide at 30° C. for 3 hours to obtain a polyamic acid solution having a concentration of 3.0% by mass. To this polyamic acid solution were added 0.5 parts by mass of a silica filler (average particle size: 0.08 μm, ST-ZL manufactured by Nissan Chemical Industries, Ltd.) based on 100 parts by mass of the polyamic acids and γ-phenylaminopropyl trimethoxy silane at a ratio such that the concentration in the solution was 3% by mass, and then the resulting mixture was homogeneously mixed to obtain a precursor solution composition (A-4) of a polyimide (a).

### Reference Example 6

3,3′,4,4′-biphenyltetracarboxylic dianhydride, pyromellitic dianhydride and 4,4-diaminodiphenyl ether at a molar ratio of 70:30:100 were polymerized in N,N-dimethylacetamide at 30° C. for 3 hours to obtain a polyamic acid solution having a concentration of 3.0% by mass. To this polyamic acid solution were added 0.5 parts by mass of a silica filler (average particle size: 0.08 μm, ST-ZL manufactured by Nissan Chemical Industries, Ltd.) based on 100 parts by mass of the polyamic acid, and γ-phenylaminopropyl trimethoxy silane at a ratio such that the concentration in the solution was 3% by mass, and then the resulting mixture was homogeneously mixed to obtain a precursor solution composition (A-5) of a polyimide (a).

### Reference Example 7

A precursor solution composition (C-1) was obtained in the same manner as in Reference Example 2, except that only γ-phenylaminopropyl trimethoxy silane was not added.

### Reference Example 8

A precursor solution composition (C-2) was obtained in the same manner as in Reference Example 3, except that only γ-phenylaminopropyl trimethoxy silane was not added.

### Reference Example 9

A precursor solution composition (C-3) was obtained in the same manner as in Reference Example 4, except that only γ-phenylaminopropyl trimethoxy silane was not added.

### Reference Example 10

A precursor solution composition (C-4) was obtained in the same manner as in Reference Example 5, except that only γ-phenylaminopropyl trimethoxy silane was not added.

### Reference Example 11

A precursor solution composition (C-1) was obtained in the same manner as in Reference Example 6, except that only γ-phenylaminopropyl trimethoxy silane was not added.

### Example 1

The precursor solution composition (B-1) obtained in Reference Example 1 as a dope for a base film was continuously flow-casted on a stainless substrate (support) such that the thickness of the heated and dried film was 35 μm, and then the film of the polyimide precursor solution was dried under hot air at 140° C., and peeled off from the support to obtain a self-supporting film. The precursor solution composition (A-2) obtained in Reference Example 2 was applied on the surface of the self-supporting film which was in contact with the support, by means of a die coater, such that the thickness after heating and drying was 0.10 μm, and then the film was gradually heated from 200° C. to 575° C. in a heating furnace for solvent removal and imidization to obtain a polyimide film (X-1).

On the surface of the polyimide film (X-1) coated with the precursor solution composition (A-2), a nickel-chrome alloy layer having a chrome concentration of 15% by weight and a thickness of 5 nm was formed as a metal layer by a sputtering method, after cleaning the surface of the polyimide film by plasma treatment. Subsequently, a copper layer having a thickness of 300 nm was formed by a sputtering method, and a copper-plated layer having a thickness of 20 μm was formed thereon by an electrolytic copper plating method, to prepare a copper plating laminated polyimide film.

The normal-state 90° peel strength and the 900 peel strength after heat treatment at 150° C. for 168 hours of the obtained copper plating laminated polyimide film were measured. The results are shown in Table 1.

Furthermore, 1 mm-pitch copper wiring was prepared from the obtained copper plating laminated polyimide film, and the depth of copper wiring buried in the film (the depth of the dented area) was evaluated. The results are shown in Table 1.

### Example 2

A polyimide film and a copper plating laminated polyimide film were prepared in the same manner as in Example 1, except that after applying the precursor solution composition (A-2) on the self-supporting film, the film was gradually heated from 200° C. to 495° C. in a heating furnace. Furthermore, the 90° peel strength and the depth of the dented area of the obtained copper plating laminated polyimide film were evaluated. The results are shown in Table 1.

### Examples 3-6, Comparative Examples 1-5

Polyimide films and copper plating laminated polyimide films were prepared in the same manner as in Example 1, except that the precursor solution compositions shown in Table 1 were used as the coating solution applied on the self-supporting film, instead of the precursor solution composition (A-2). Furthermore, the 90° peel strength and the depth of the dented area of the obtained copper plating laminated polyimide film were evaluated. The results are shown in Table 1.

### Reference Example 12

The precursor solution composition (B-1) obtained in Reference Example 1 as a dope for a base film was continuously flow-casted on a stainless substrate (support) such that the thickness of the heated and dried film was 35 μm, and then the film of the polyimide precursor solution was dried under hot air at 140° C., and peeled off from the support to obtain a self-supporting film. The N,N-dimethylacetamide solution, which was obtained by adding γ-phenylaminopropyl trimethoxy silane thereto at a ratio such that the concentration in the solution was 3% by mass, and homogeneously mixing, was applied on the surface of the self-supporting film which was in contact with the support, by means of a die coater, and then the film was gradually heated from 200° C. to 495° C. in a heating furnace for solvent removal and imidization to obtain a polyimide film (Y-2).

On the surface of the polyimide film (Y-2) coated with the N,N-dimethylacetamide solution of γ-phenylaminopropyl trimethoxy silane, a nickel-chrome alloy layer having a chrome concentration of 15% by weight and a thickness of 5 nm was formed as a metal layer by a sputtering method, after cleaning the surface of the polyimide film by plasma treatment. Subsequently, a copper layer having a thickness of 300 nm was formed by a sputtering method, and a copper-plated layer having a thickness of 20 μm was formed thereon by an electrolytic copper plating method, to prepare a copper plating laminated polyimide film.

The normal-state 90° peel strength and the 90° peel strength after heat treatment at 150° C. for 168 hours of the obtained copper plating laminated polyimide film were measured. The results are shown in Table 1.

Furthermore, 1 mm-pitch copper wiring was prepared from the obtained copper plating laminated polyimide film, and the depth of copper wiring buried in the film (the depth of the dented area) was evaluated. The results are shown in Table 1.

### Comparative Example 6

The precursor solution composition (B-1) obtained in Reference Example 1 was used as a dope for a base film, and the precursor solution composition (C-2) obtained in Reference Example 3 was used as a dope for a surface layer. Using a film-forming apparatus equipped with a three-layer extrusion molding die (multi-manifold type die), a three-layer polyamic acid solution was continuously flow-casted on a stainless substrate (support) such that the thickness of the heated and dried base film was 35 μm and the thickness of each surface layer film was 3 μm (41 μm in total), and then the film of the three-layer polyamic acid solution was dried under hot air at 140° C., and peeled off from the support to obtain a self-supporting film. This self-supporting film was gradually heated from 200° C. to 575° C. in a heating furnace for solvent removal and imidization to obtain a polyimide film (Y-1).

On the coated surface of the polyimide film (Y-1), a nickel-chrome alloy layer having a chrome concentration of 15% by weight and a thickness of 5 nm was formed as a metal layer by a sputtering method, after cleaning the surface of the polyimide film by plasma treatment. Subsequently, a copper layer having a thickness of 300 nm was formed by a sputtering method, and a copper-plated layer having a thickness of 20 μm was formed thereon by an electrolytic copper plating method, to prepare a copper plating laminated polyimide film.

The normal-state 90° peel strength and the 90° peel strength after heat treatment at 150° C. for 168 hours of the obtained copper plating laminated polyimide film were measured. The results are shown in Table 1.

Furthermore, 1 mm-pitch copper wiring was prepared from the obtained copper plating laminated polyimide film, and the depth of copper wiring buried in the film (the depth of the dented area) was evaluated. The results are shown in Table 1.

TABLE 1

| | | | | | | | Properties | | |
|---|---|---|---|---|---|---|---|---|---|
| | | Polyamic acid monomer composition | | | | | | 90° peel strength | |
| | | Acid component | | Diamine component | | | 90° peel strength | after heating at | Depth of |
| | Coating | s-BPDA | PMDA | DADE | PPD | Amino | in normal state | 150° C. for 168 hours | dented area |
| | solution | mole % | mole % | mole % | mole % | silane | kgf/cm | kgf/cm | mm |
| Example 1 | A-2 | 100 | 0 | 100 | 0 | Yes | 1.44 | 0.96 | 0.20 |
| Example 2 | A-2 | 100 | 0 | 100 | 0 | Yes | 1.10 | 0.55 | 0.26 |
| Comparative | C-2 | 100 | 0 | 100 | 0 | No | 0.19 | 0.04 | 0.29 |
| Example 1 | | | | | | | | | |
| Example 3 | A-3 | 100 | 0 | 80 | 20 | Yes | 1.40 | 0.70 | 0.31 |
| Comparative | C-3 | 100 | 0 | 80 | 20 | No | 0.64 | 0.12 | 0.33 |
| Example 2 | | | | | | | | | |
| Example 4 | A-4 | 100 | 0 | 30 | 70 | Yes | 0.96 | 0.60 | 0.35 |
| Comparative | C-4 | 100 | 0 | 30 | 70 | No | 0.36 | 0.04 | 0.32 |
| Example 3 | | | | | | | | | |
| Example 5 | A-1 | 100 | 0 | 0 | 100 | Yes | 1.00 | 0.68 | 0.25 |
| Comparative | C-1 | 100 | 0 | 0 | 100 | No | 0.12 | 0.02 | 0.29 |
| Example 4 | | | | | | | | | |
| Example 6 | A-5 | 70 | 30 | 100 | 0 | Yes | 1.58 | 1.03 | 0.30 |
| Comparative | C-5 | 70 | 30 | 100 | 0 | No | 0.31 | 0.03 | 0.28 |
| Example 5 | | | | | | | | | |
| Reference | — | — | — | — | — | Yes | 0.65 | 0.38 | 0.23 |
| Example 12 | | | | | | | | | |
| Comparative | C-2 | 100 | 0 | 100 | 0 | No | 1.50 | 0.90 | 1.06 |
| Example 6 | | | | | | | | | |

In Table 1, s-BPDA: 3,3′,4,4′-biphenyltetracarboxylic dianhydride,
PMDA: pyromellitic dianhydride,
DADE: 4,4′-diaminodiphenyl ether,
PPD: p-phenylenediamine.

These Examples indicate the following matters:

1) When comparing Examples 1 to 6 and Reference Example 12 with respect to the difference in peel strength due to a method of coating the polyimide film with aminosilane, higher 90° peel strength (in a normal state, and after heat treatment at 150° C.) is achieved when aminosilane in a polyamic acid solution is applied on the polyimide film.

2) When comparing Examples 1 to 6 and Comparative Examples 1 to 5 with respect to the difference in peel strength due to the presence of aminosilane in the polyamic acid solution to be applied on the polyimide film, higher 90° peel strength (in a normal state, and after heat treatment at 150 DC) is achieved when a polyamic acid solution containing aminosilane is applied on the polyimide film.

3) When comparing Examples 1 to 5 with respect to the difference in peel strength due to the monomer composition of the polyamic acid solution to be applied on the polyimide film, higher 90° peel strength (in a normal state, and after heat treatment at 150° C.) is achieved when a polyamic acid solution containing a relatively large amount of DADE is applied on the polyimide film in Examples 1 and 3.

4) In the system wherein aminosilane is not added,

(i) as the surface layer of the polyimide layer is thinner, the peel strength is lower, while the depth of a wiring buried in the polyimide film is reduced (Comparative Example 1), and

(ii) as the surface layer of the polyimide layer is thicker, the depth of a wiring buried in the polyimide film is greater, while the peel strength is higher (Comparative Example 6).

In contrast, in the system wherein aminosilane is added, both of the higher peel strength and the less depth of a wiring buried in the polyimide film are achieved (Example 1).

5) When comparing Example 1 and Example 2, higher 90° peel strength (in a normal state, and after heat treatment at 150° C.) is achieved in Example 1 involving heat treatment at a higher temperature.

1. A polyimide film for metallizing, having a polymide layer (a) on one side or both sides of a polyimide layer (b),
wherein the polyimide layer (a) contains a surface treatment agent.

2. A polyimide film for metallizing, having a polyimide layer (a) on one side or both sides of a polyimide layer (b),
wherein the polyimide layer (a) is subjected to a heat treatment at the highest heating temperature of from 350° C. to 600° C. in a state in which it contains a surface treatment agent.

3. A polyimide film for metallizing, obtained by
coating a self-supporting film of a polyimide precursor solution (b) to give a polyimide layer (b) with a polyimide precursor solution (a) containing a surface treatment agent to give a polyimide layer (a); and
heating the self-supporting film of the polyimide precursor solution (b) coated with the polyimide precursor solution (a) containing a surface treatment agent at the highest heating temperature of from 350° C. to 600° C.

4. The polyimide film for metallizing as claimed in claim 1, wherein the polyimide layer (a) has a thickness of from 0.05 to 1 μm.

5. The polyimide film for metallizing as claimed in claim 1, wherein the surface treatment agent is a component selected from the group consisting of an aminosilane compound and an epoxysilane compound.

6. The polyimide film for metallizing as claimed in claim 1, wherein the polyimide layer (b) and the polyimide layer (a) are polyimides obtained from
1) an acid component comprising at least one component selected from the group consisting of 3,3′,4,4′-biphenyltetracarboxylic dianhydride, pyromellitic dianhydride, and 1,4-hydroquinone dibenzoate-3,3′,4,4′-tetracarboxylic dianhydride, and
2) a diamine component comprising at least one component selected from the group consisting of p-phenylenediamine, 4,4-diaminodiphenyl ether, o-tolidine, m-tolidine, and 4,4′ diaminobenzanilide.

7. The polyimide film for metallizing as claimed in claim 1, wherein the polyimide layer (a) is a polyimide obtained from
1) an acid component comprising 3,3′,4,4′-biphenyltetracarboxylic dianhydride, and
2) a diamine component comprising at least one component selected from p-phenylenediamine and 4,4-diaminodiphenyl ether.

8. A metal-laminated polyimide film, comprising a polyimide film for metallizing as claimed in claim 1,
wherein a metal layer is formed on the surface of the polyimide layer (a) of the polymide film for metallizing by a metallizing method.

9. The metal-laminated polyimide film as claimed in claim 8, wherein the depth of a metal wiring buried in the polyimide film is 0.4 mm or less, and the metal-laminated polyimide film has a normal-state 90° peel strength of 0.08 N/mm or higher.

10. A metal plating laminated polyimide film, comprising the metal-laminated polyimide film as claimed claim 8,
wherein a metal-plated layer is formed on the metal layer of the metal-laminated polyimide film by a metal plating method.
